(19) United States
(12) Patent Application Publication
(10) Pub. No.: US 2013/0216921 A1
(43) Pub. Date: Aug. 22, 2013

(54) PORTABLE METAL-AIR BATTERY ENERGY SYSTEM FOR POWERING AND/OR RECHARGING ELECTRONIC DEVICES

(71) Applicants: Kevin Maloney, Newport Beach, CA (US); R. Douglas Carpenter, Tustin, CA (US)

(72) Inventors: Kevin Maloney, Newport Beach, CA (US); R. Douglas Carpenter, Tustin, CA (US)

(73) Assignee: QUANTUMSPHERE, INC., Santa Ana, CA (US)

(21) Appl. No.: 13/401,399

(22) Filed: Feb. 21, 2012

(51) Int. Cl. H01M 8/22; H02J 1/00

(52) U.S. Cl. 429/403; 307/43

(57) ABSTRACT

A system is provided for delivering energy to an electronic device, where the system comprises a metal-air battery having one or more metal-air cells within a housing, a first surface having at least one air hole therein for permitting the influx of air from the surrounding ambient into the interior of the battery housing for exposure to the one or more cells, and a cover that may be entirely or partially moved relative to the air hole for selectively controlling the exposure of the air hole to the ambient when it is desired to generate energy for discharge to the rechargeable power source. The system may include a carriage for positioning the battery therewithin in a removable and/or repositionable manner.

### BACKGROUND OF THE INVENTION

With the ubiquity of consumer electronics, as well as many other products powered by stored energy, and the attachment to such products that users have, a need exists to provide the user with the ability to power directly or recharge electronic devices while traveling, and often quickly. Numerous formats exist for attempting to address this problem, whether it is the user traveling with an ample supply of double-A and triple-A batteries, or their having purchased a back-up battery where product-specific batteries are required for the product, or whether it requires the user to purchase and transport more elaborate recharging systems, including fuel cells or other means of harnessing electrochemical and even thermal energy.

Yet competing issues remain, economic viability and appeal versus the production and disposal of such recharging formats. It has been established that certain catalysts enhance the efficiency and durability of electrochemical energy for batteries and fuel cells. For example, the use of catalytic nano-metals produced by a process described in U.S. Pat. No. 7,282,167 to Douglas Carpenter of QuantumSphere, Inc. of Santa Ana, Calif., and described for numerous commercial applications in other patents and patent applications assigned to QuantumSphere, has proven very effective in high efficiency power storage and delivery. In that regard, reference is made to electrodes made using such catalytic nano-metals, including those expressly described in U.S. patent application Ser. No. 11/254,629, filed Oct. 20, 2005, (published as No. 2007-0092784), the entire contents of which are incorporated herein expressly by reference.

Yet, even then, consumer needs and desires, both sensible and fickle, are dynamic. Form factor is a very important design parameter, as it impacts not only convenience and portability, but also visual appeal. Light, powerful, sleek, and low-profile, are just some of the metrics by which consumers select electronic products. Coupled with a growing desire to empower our society with energy that has minimal ecological impact, there is a need to provide updated recharging technology that is efficient, effective, appealing, portable, virtually non-toxic and can be disposed of in an acceptable manner. Indeed, several entities are engaged in research to address these competing needs, with some having already launched commercially. Yet, there is still room for improvements. There is a strong trend toward rechargeability-reusability, even of the recharging source itself (e.g., rechargeable batteries, fuel cells that can be recharged, etc.). While beneficial in some respects, disposability, also has advantages.

For example, primary metal-air batteries, including zinc-air batteries, are not electrically rechargeable and must be disposed after use, but offer an effective power source given its low cost and high energy density. Typical zinc-air batteries have a button form factor, and comprise an anode of zinc and electrolyte, a cathode positioned discretely from the anode by a separator and insulator gasket, and a current collector. The cell includes a housing enclosing the electrodes, with an inlet through the wall on the cathode side for air exposure to the cathode through a semi-permeable membrane. Normally, zinc is mixed into a paste with an electrolyte to form a porous anode. Oxygen from the air reacts at the cathode and forms hydroxyl ions that migrate into the zinc paste and form zincate (Zn(OH)₄), releasing electrons that can travel to the cathode. Eventually, the zincate decays into zinc oxide, with the water and hydroxyls from the anode being reused at the cathode. The known chemical reactions that take place in a zinc-air battery are as follows:

Anode: Zn+4OH⁻→Zn(OH)₄²⁻+2e⁻ (E₀=−1.25 V)

Fluid: Zn(OH)₄²⁻→ZnO+H₂O+2OH⁻

Cathode: ½O₂+H₂O+2e⁻→2OH⁻ (E₀=0.34 V pH=11)

Overall: 2Zn+O₂→2ZnO (E₀=1.59 V)

Although zinc-air batteries are theoretically capable of producing almost 1.6 volts, due to practical inefficiencies, a normal zinc-air battery provides about 1.4 volts of energy.

Embodiments of the inventions described below address at least some of the needs discussed above, and take advantage of the advantages of high energy densities, abundant low cost materials, and eco-friendly disposability.

### SUMMARY OF THE INVENTION

In one embodiment of the present invention, a system is provided for delivering energy to an electronic device, where the system comprises a metal-air battery having one or more zinc-air cells within a housing. The housing preferably includes at least one opening for permitting the influx of air from the surrounding ambient into the interior of the battery housing for exposure to the one or more cells. A plurality of air holes, in one or more of a variety of configurations and shapes are contemplated.

The battery system further comprises a cover that may be entirely or partially moved relative to the opening for selectively controlling the exposure of ambient air when it is desired to generate energy for discharge to the rechargeable power source. The cover may be moved by sliding, rotating, pivoting, peeling, collapsing, or one of many other formats, depending upon the construction and configuration of the cover and/or the housing in which the cells are positioned. The cover may be removable or not, with removable covers being reusable or disposable.

The battery further comprises a connector for permitting electrical connection between the system and the electronic device. In one embodiment, the connector may be a lead wire terminating with a connector, or the connector may be an electrical port. In another embodiment, a transformer may be used to change the voltage.

The system may further comprise a carriage for supporting the battery in a manner where the battery may be easily removed and/or repositioned. Preferably, electrical contacts are provided both on the battery and on the carriage so electrical communication may occur between the two when the battery is positioned within the carriage. In an alternative embodiment, no cover is provided on the battery, and exposure of the air hole(s) is controlled by orienting the battery within the carriage in a certain position or orientation. Where the battery has one face with one or more air holes, and an opposite face with no air holes, flipping the battery within the carriage can alternatively expose the air holes or seal off the air holes.

Embodiments of the invention herein may be used to recharge batteries employed in an electronic device, or simply to power the device directly. Such devices may include one of number of consumer electronic devices, including computer-based devices or less complex devices such as flashlights, as well as larger devices such as those used in commercial and industrial applications, or even in vehicles. Other possible applications are contemplated as well for the battery systems described herein.

### BRIEF DESCRIPTION OF THE DRAWINGS

FIGS. 1A-1C are schematic views of one embodiment of the present invention;

FIGS. 2A and 2B are schematic views of the embodiment of FIG. 1;

FIGS. 3A-3C are schematic views of a second embodiment of the present invention;

FIG. 4 is a schematic view of one embodiment of the invention applied to a user's electronic device; and

FIGS. 5A-5B are schematic views of alternative embodiments of the present invention, showing indicia of mode of operation of the battery;

FIGS. 6A-6B are schematic views of alternative arrangements of the present invention;

FIG. 6C is a schematic view of one application of the arrangements of FIGS. 6A and 6B;

FIG. 6D is a schematic view of one application of the embodiment of FIG. 6C.

### DETAILED DESCRIPTION OF SOME PREFERRED EMBODIMENTS

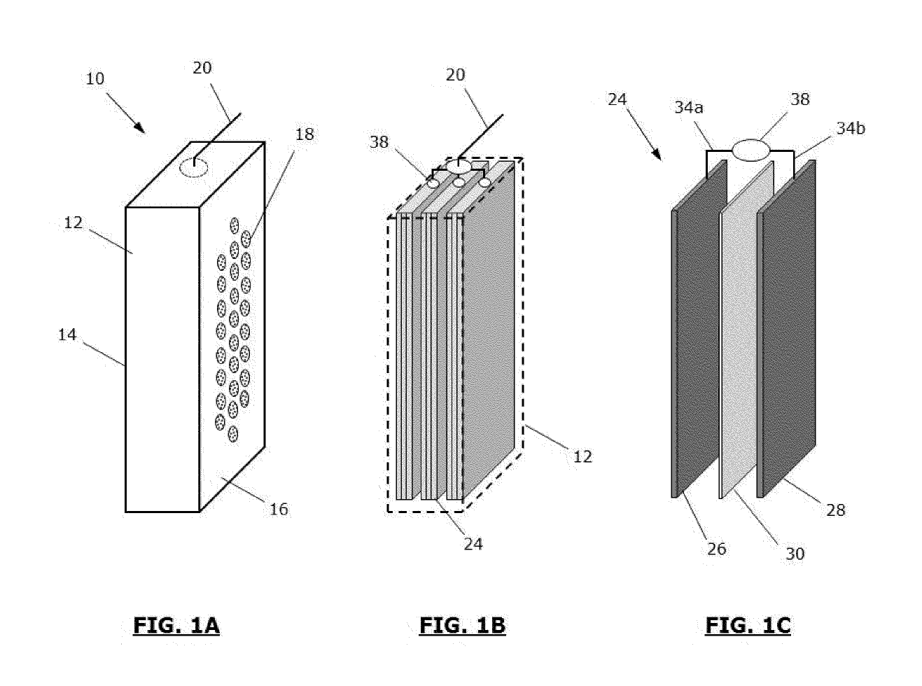

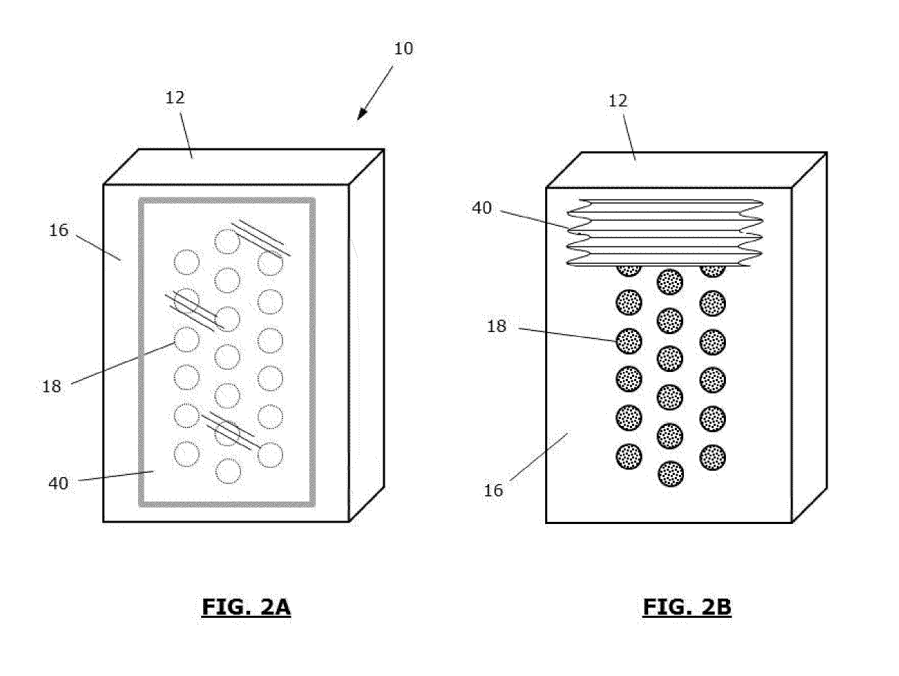

Referring to FIGS. 1A-1C, one embodiment of a disposable metal-air energy storage system includes a zinc-air battery 10 comprising a plastic housing 12 having a first face 14 and an opposing second face 16. The housing is preferably made of recyclable acrylonitrile butadiene styrene, commonly referred to as ABS, but other materials may be used for the housing if so desired. A balance of weight, strength and durability is important, as well as its impact on the environment.

As a vehicle for permitting the influx of air, the second face 18 of housing 12 comprises one or more openings 18 for permitting an exchange of air within the interior of the housing 12, as shown specifically in FIG. 1A. The holes may or may not be covered by a screen for precluding the undesired influx of air-entrained debris.

The zinc-air battery 10 embodiment of FIG. 1A-1C further comprises a lead 20 from which energy may be delivered to a rechargeable device (not shown), such as a cell phone, smart phone, computer, etc. Depending upon the embodiment of both the device and the battery, lead 20 may terminate in one of a number of possible connectors that permit electrical interface between the rechargeable device and the battery, such as a USB port.

Referring to FIG. 1B, the housing 12 (shown in phantom) encloses a plurality of zinc-air cells 24 comprising a plurality of components described in association with FIG. 1C. The cells 24 are preferably stacked one in front of another in a configuration that permits some air space to flow between the cells so that air entering the openings 18 of second face 16 during use may access each zinc-air cell. In one embodiment, the cells 24 are spaced apart by a layer of poly mesh material that permits air travel therewithin. Of course, other materials and other configurations may be employed for permitting the free flow of air to each cell sufficient to allow the zinc-air battery reactions.

Referring to FIG. 1C, one of the zinc-air cells 24 within the housing 12 of the zinc-air battery 10 may be seen by example comprising a plurality of electrodes 26, 28 and a separator 30 therebetween. The first electrode 26 is an anode, while the second electrode 28 is a cathode.

The anode 26 preferably comprises an active metal, an electrolyte, deionized water and a binding gel. In one embodiment, the active metal comprises zinc particles. The electrolyte may comprise, for example, potassium hydroxide (KOH), with the binding gel comprising, for example, a Lubrizol® brand gelling agent such as Carbopol® EZ-3. The zinc, KOH electrolyte, binding gel and water are mixed to create a porous paste that resides preferably on a robust conductive mesh substrate such as nickel. Other materials may be used for the anode 26 in addition to or in substitution of the zinc, (KOH), water and binding gel, although the energy potential may differ, and the rate of discharge and storage life may also differ.

The cathode 28 preferably comprises nano-catalyst and carbon powder mixed with, for example, a fluorocarbon material, such as liquid Teflon® material, to form a ribbon-like substance applied to a nickel screen that serves as the current collector. These ingredients are applied to a porous Teflon® hydrophobic membrane to form the cathode 28. The nano-catalyst preferably comprises manganese or manganese alloy preferably made by, for example, a process described in the '167 patent to Carpenter referred to above. Preferably, the nano-catalyst comprises an external layer of oxide of the metal with a metal core to enhance stability and performance of the catalyst. The porous Teflon layer lets oxygen enter through the cathode 28 but restricts the exchange water into or out of the cell.

As with the anode, other materials may be chosen in addition to or in lieu of these materials if so desired. Other catalytic nano-metals may be used for the metal-air battery electrodes, including, for example, nickel, cobalt, silver, alloys thereof, and their respective oxides. Chromium, ruthenium, palladium, lead, iron, gold, and their associated alloys and oxides, among other metals, are also useful in some embodiments. Moreover, the possible variations on the composition of the cathode are described in more detail in U.S. patent application Ser. No. 11/254,629, filed Oct. 20, 2005, (published as No. 2007-0092784), the entire contents of which are incorporated herein expressly by reference.

In making the cell 24, the anode 26 and cathode 28 are adhesively joined to either side of the separator 30, which is formed of for example Celgard 5550-1270M-A, although other materials would be suitable. The separator membrane permits controlled exchange of reactants between the anode and cathode with minimum impeding of the zinc-air reaction that generates current at a desired voltage. In that regard, lead wires 34a and 34b extend from both electrodes to deliver energy at point 38 so that a plurality of cells 24 may be wired in parallel or series depending upon the energy output desired. It should also be noted, however, that depending upon the current and voltage level desired, a single metal-air cell may be sufficient within the battery housing. In either case, as exemplified by the embodiment of FIGS. 1A-1C, the collective energy from each cell 24 can be delivered along lead wire 20. When positioned within a housing, it is preferred that the cathode of a single or multiple cells be positioned in the direction of the second face of the housing that contains the air inlet holes, to facilitate the flow of air.

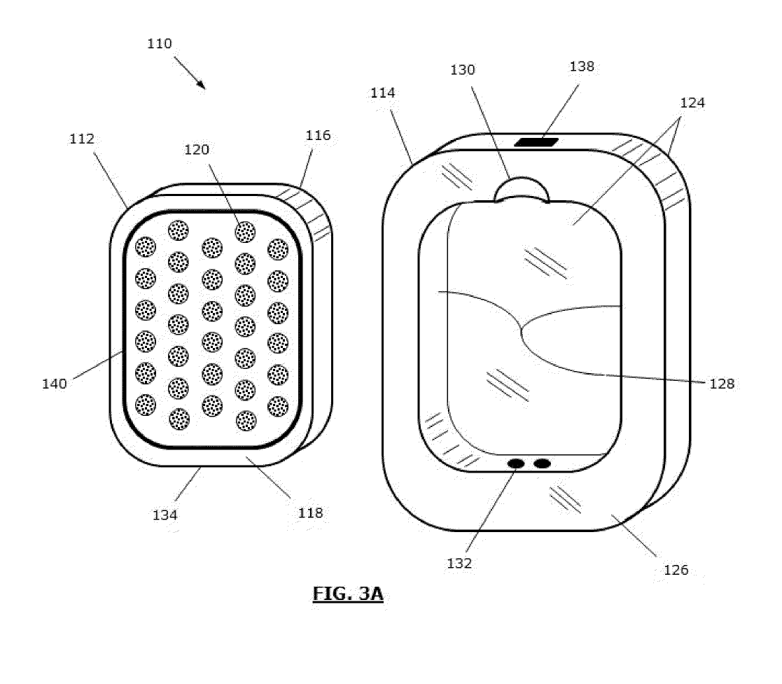

Referring now to FIGS. 2A and 2B, one embodiment of the present invention includes a removable cover 40 that adheres to second face 16 of the housing 12 in a manner so as to cover the air holes 18 (shown in phantom in FIG. 2A). The cover 40 may be made of any material that permits a user to easily remove at least a part of it from the second face 16 of the housing 12 so as to expose some if not all of the holes. In some embodiments, it may comprise a sturdy rotatable or slidable cover affixed in a pivot or channel fashion to the battery housing, in a manner not unlike the variety of ways that mobile phones are configured to cover and expose the keyboard.

In an alternative embodiment, and referring to FIG. 2B specifically, the cover 40 may comprise a thin resilient synthetic material that may remain adhered to the second face 16 at one end 42 while the rest of the cover 40 is pulled back in a rolled-up form, accordion form (as shown in FIG. 2B), or some other fashion. The adhesive applied to sustain the cover 40 over the air holes 18 is preferably of the type that is reusable so that where the one end 42 of the cover 40 remains affixed to housing 12, the cover 40 may be re-adhered to the housing so as to completely cover the air holes. Such a configuration permits temporary use of the system 10 where less than an entire discharge of the zinc-air battery is desired. Of course the entire cover 40 may be adhered to the second face 16 with reusable adhesive so that it can be entirely removed from the housing to expose the air holes 18, and later reaffixed to completely cover the air holes. A variety of possibly configurations and materials are contemplated for the cover 40 so long as the user may control the exposure of the air holes 18 to ambient air to start and stop the zinc-air reactions that generate energy for delivery to power directly or recharge a user's device.

The advantage of providing a metal-air battery comprising a housing with air holes provided in at least one wall of the housing, and a cover to controllable expose air holes to ambient air, is that the system may function for long term storage by the user with the ability to start and stop the energy generating reaction as needed. Such an arrangement and configuration provides optimal benefit to a user with one or more rechargeable electronic devices who does not desire to maintain a supply of “back-up” batteries for each of the electronic devices. Disposability also provides an advantage of eliminating the need to recharge both an external rechargeable battery and the electronic device battery. It should also be noted that the battery may comprise one of a variety of shapes and configurations while still providing the beneficial advantages discussed above. The invention is not limited to a rectilinear housing profile, and may comprise curvilinear profiles if so desired.

It is contemplated that the lead wire 20 of the embodiments of FIGS. 1A-1C and 2A-2B may be replaced with a port (not shown) that comprises a connector, such as a USB port, for transferring energy to the user's electronic device. Male or female ports may be provided as desired to adapt to one or more types of user devices.

It is also contemplated that the air holes may be of any shape and configuration. Indeed, there may be one large one, or a plurality of smaller ones as described herein. The holes may be round, ovate, rectilinear, curvilinear or of any other shape that reflects functional and/or aesthetic appeal, including slots and cross-shapes.

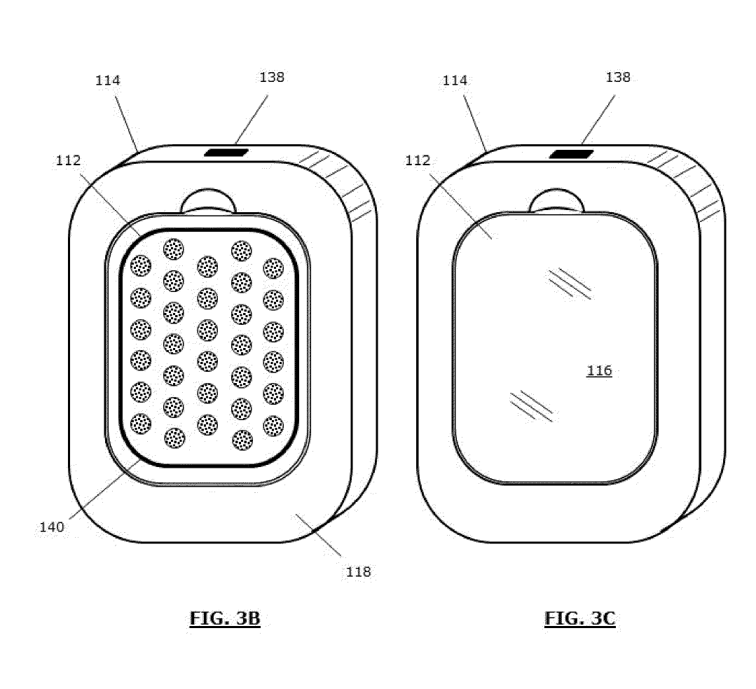

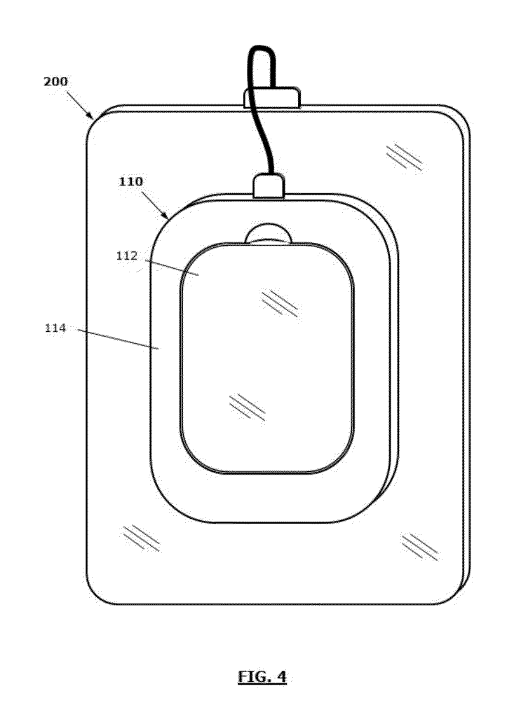

Referring to FIGS. 3A-3C, in an alternative embodiment of the present invention, a system 110 is provided that comprises a metal-air battery 112 and a carriage 114 for securably storing and transporting the battery 112. As with the earlier embodiments, the metal-air battery 112 comprises a first surface 116 and a second opposing surface 118 in which one or more air holes 120 are provided.

The carriage 114 comprises, in this example, a frame-like configuration comprising a first face 124 and a second opposing face 126, and an interior space 128 configured and sized to accommodate a removably secured position of the metal-air battery 112. In the embodiment illustrated, the first face 124 may be visible through the space 128, although it need not be. Where the space 128 is configured to closely conform to the profile of the battery 112, an optional notch 130 may be provided to facilitate removal of the battery when lodged within the space. FIGS. 3B and 3C show the battery 112 positioned within the space 128.

In one respect, the embodiment of FIGS. 3A-3C differ from the above embodiments in that no lead wire is provided from the battery 112 itself. Rather, a mating set of first electrical contacts 132 (on the carriage 114) and second electrical contacts 134 (on the battery—not visible) are provided to transfer the electrical energy from the battery 112 to the carriage 114. From there, the energy may be made available to a user's electronic device through a lead wire or, in this example, a connector 138 on the exterior of the carriage 114. The connector 138 may comprise one of a variety of ports, including for example a USB port or other IEEE connector, from which a cable may be used to transfer energy to the user's device. Referring to FIG. 4, one embodiment of system 110 comprising a battery 112 and carriage 114 is shown connected via a cable 150 to a user's electronic device 200.

Preferably, a seal is provided either on the battery 112, or within the space 128, or both, so that when the battery is oriented with the air holes 120 facing inwardly, the seal precludes the flow of ambient air into the air holes. In the embodiment illustrated in FIGS. 3A and 3B, the seal comprises a gasket 140 provided on the second surface 118 surrounding the air holes 120. When the battery is placed within the space 128 with second surface 118 oriented inwardly, as shown in FIG. 3C, the seal compresses against an inner surface of the carriage 114, for example the first face 124, to preclude ambient air reaching the air holes. The seal may comprise a gasket on the interior of the space 128, or a plurality of gaskets may be provided, depending upon the profile of the battery 112 and space 128 in the carriage 114.

One advantage of the configuration of the embodiments such as that shown in FIGS. 3A-3C is that user control of the energy-generating reaction within the battery may be maintained by the orientation of the battery 112 within the carriage 114. In FIG. 3C, the battery 112 may be oriented so that the air holes 120 are not exposed to the ambient, thus precluding energy generation while the battery is stored in that position within the carriage. When it is desired to generate energy for delivery to a user's device, a user may simply remove the battery 112 from the carriage 114, flip it to the other side, and reinsert it into the space 128 so that the air holes 120 of second surface 118 are exposed, as shown in FIG. 3B. The ability to remove and flip provides one way in which a user of the present invention may control the generation of stored or recharging energy. Once the user's electronic device is powered or recharged sufficiently, the user may reorient the battery 112 within the space 128 of the carriage 114 so that the first surface 116 is presented outwardly, thus stopping further air influx into the battery. The carriage and battery may then continue to be stored for later use.

It is contemplated that, in some embodiments, the carriage may be adhered to one surface of the user's electronic device so that it is transported with the device and, thereby, easily accessible as recharging of the device's battery is required. In that regard, the first face 124 of the carriage 114 may be provided with an adhesive material that is reusable; i.e., that it may be sufficiently strong to adhere to an adjacent surface of a separate electronic device, but may be removed easily without losing its adhesive ability. Once the battery (for example battery 112) is fully discharged, a new battery may be placed inside the carriage or, if so desired, the entire battery and carriage disposed and replaced with a new set of battery and carriage.

Although not shown, the system 110 of FIGS. 3A-3C, in an alternative arrangement, may comprise a cover in one of the variety of configurations described above in association with the embodiments of FIGS. 2A and 2B. In yet other embodiments, a generally rigid cover may be provided that slides within a channel in the housing of the battery in which, in one position, air holes below the cover remain sealably covered from exposure to ambient air and, in another position, the air holes are exposed. The indicator may comprise a negative sign for when the battery is in inactive mode (i.e., the air holes are sealed off from the ambient) and may further comprises a positive sign for when the battery in is discharge mode available for recharging a user's electronic device. Moreover, the air holes in the metal-air battery need not be positioned on a large first or second face of the battery, but rather may be positioned along a shorter top or bottom or transverse face, with one of a variety of possible actuatable covers, such as are described herein. Moreover, in yet other embodiments, the carriage may be open on both sides permitting release of the battery from either side, but where removable covers are provided to control air exposure to the interior of the battery. In other words, a rear wall of the carriage need not be employed as a means for blocking air to the battery.

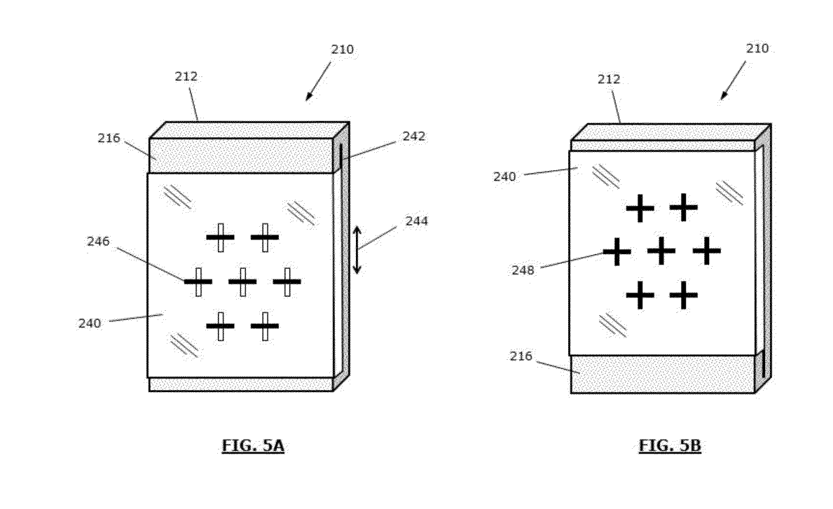

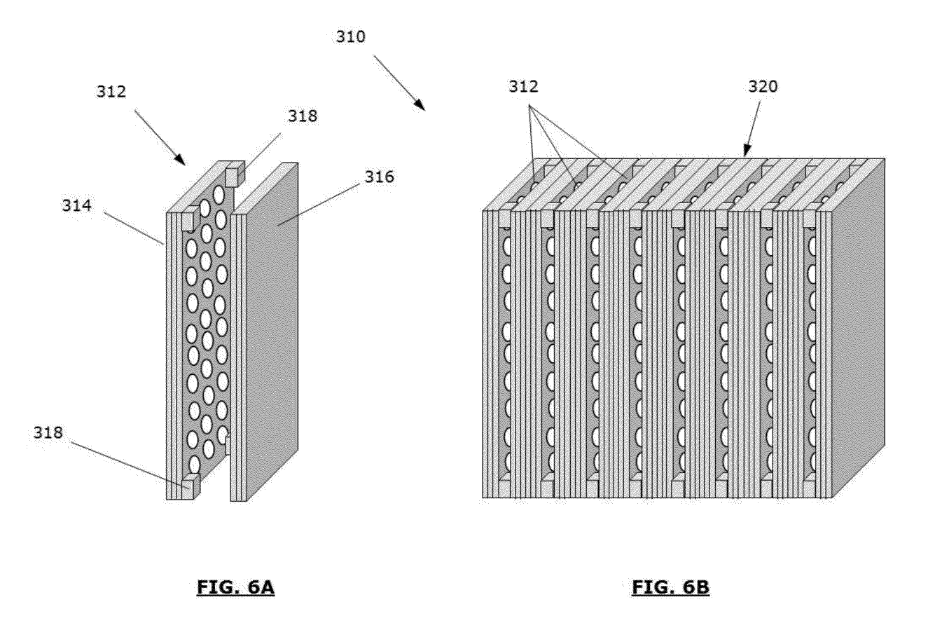

Referring to FIGS. 5A and 5B, one embodiment of a battery comprises an indicator of whether the battery is in discharge mode or in inactive mode. For example, metal-air battery 210 comprises a housing 212 comprising a first surface 216 comprising an array of air holes (not shown) hidden by generally rigid cover 240 that can be moved between a first position and a second position along channel 242 in the direction of arrow 244. In this example, the first position is at a lower point on the housing, as shown in FIG. 5A, and the second position is an upper point on the housing, as shown in FIG. 5B.

Preferably the cover 240 comprises a plurality of openings that reflect indicia of operation mode, where the openings generate a first visual impression in one mode of operation and a second visual impression in a second mode of operation (i.e., inactive versus discharge modes). In one embodiment, shown in FIG. 5B, with the cover 240 in a position to preclude exposure of the air holes in housing 212 from the ambient, the cover holes are configured as a cross with one of the two legs of the cross emboldened (more pronounced) so as to give a “negative sign” appearance. When the cover 240 is moved to the upper position, as shown in FIG. 5B, so that the air holes below the cover are now exposed to the ambient, the exposure of the holes creates the visual appearance of a “positive sign” in which both legs of the cross are emboldened. A person of ordinary skill in the art should appreciate the variety of cover hole and air hole configurations and shapes to create different visual impressions as indicia of battery mode of operation.

It is important to recognize that a battery with a cover provided to control ambient air accessing the interior of the battery may be used with a carriage or self-standing. Where a cover is provided, the battery may reside in the carriage merely for convenience of transport, but it need not be removed and flipped over to activate the battery. Removal (partial or whole) or movement of the cover to expose the air holes in the battery would be sufficient to activate the battery. Once fully discharged, the battery may be removed from the carriage for disposal and replaced with a new battery of the type described herein.

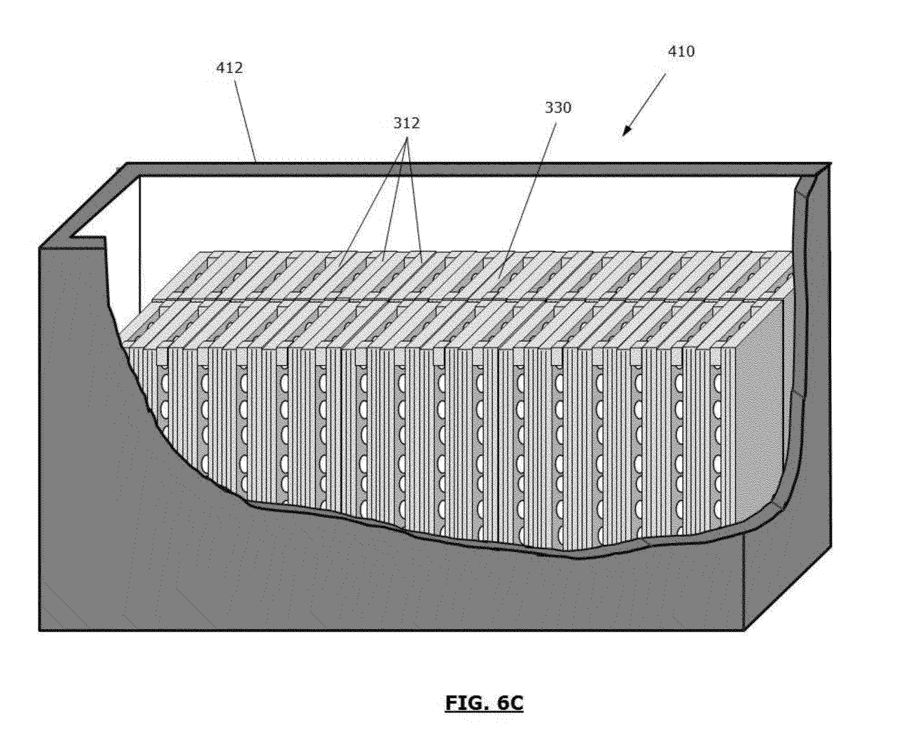

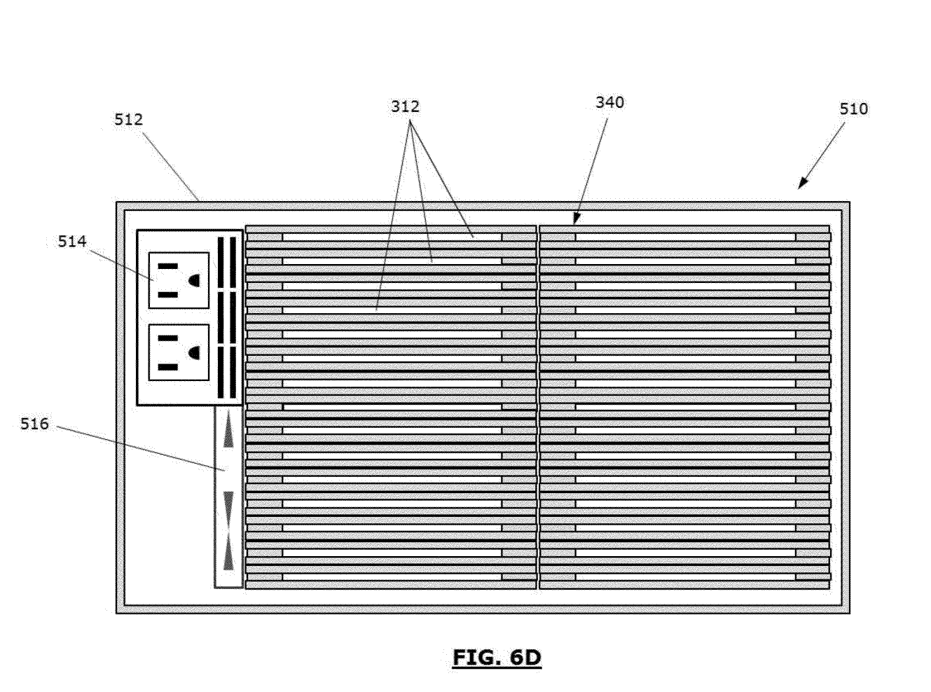

Referring to FIGS. 6A and 6B, one of several alternative arrangements may be appreciated for using the battery cells described herein. Specifically, it is contemplated that several cells may be joined together to provide portable robust power on a larger scale. For example, where a user is remotely situated far from any facility, with a sufficient contingent of equipment requiring power, a more robust portable battery system would be beneficial, and the present invention can address such needs. In that regard, one alternative embodiment 310 comprises a set 312 of two cells 314, 316 sandwiching one or more spacers 318 positioned to permit the flow of air to the space created between the cells. Orienting the air hole side of each battery cell 314, 316 toward the interior space permits a plurality of such cell sets to be joined together to form a portable monolithic arrangement 320 wired in parallel and/or in series to increase the potential power output.

Of course, it may be appreciated that the possible physical arrangement for a plurality of such joined cell sets is inumerable, but one example 410 is shown in FIG. 6C, where a plurality of sets 312 are arranged in two adjacent rows to form a portable monolithic battery 330, or alternatively a plurality of batteries electrically linked or linkable together. By physically securing the sets of cells together, they may be moved as a monolithic piece into a housing 412 having an opening in the top surface thereof to store for later use as a source of power.

In one particular battery system 510, shown in FIG. 6D, an alternative portable battery 340 comprising a plurality of cells 312 (monolithic or not) may be provided in a removable manner within housing 512 having an opening in the top surface thereof. By employing a transformer 514 to vary the voltage output, and one or more fans 516 positioned to pro-actively direct air though the spaces of cells 312, the system 510 acts as a portable yet robust energy source to power equipment remotely, safely, and quietly. The transformer effectively comprises one of a number of possible connectors for permitting electrical connection between the battery system and any electronic device needing power and/or recharge. The monolith battery 340 of cells 312 is preferably light enough for easy transport within housing 512, and may be replaced with a substitute monolith of either the same or different arrangement for attachment to the transformer and/or fans.

It is contemplated that the housing 512 have a sealable lid or cover (not shown) to preclude exposure of the battery cells 312 to ambient air during remote transport of the portable power system 510. When power is desired, the cover or lid may be opened or pulled back (depending upon the particular configuration) to expose the battery 340 to air permitting the battery cells to generate power. If desired, the lid may be fashioned to sealably expose the outlets of the transformer for quick recharge of or power for an external device using residual air within the housing 512 with minimal exposure of the battery 340 to the air (preserving power for later discharge).

It is important to note that a plurality of battery systems 510 may be electrically linked in series and/or parallel to increase voltage and/or amperage. Such flexibility is important where higher power output is necessary in the context of larger industrial, medical and/or military equipment off the grid or in a back-up mode of operation.

It should be appreciated that numerous variations on the shape and configuration of the battery and/or the carriage are contemplated that reflect functional and aesthetic appeal to consumers. Moreover, aesthetics may take a back seat to functionality where the present invention is adapted for industrial use or in large scale formats. Indeed, it is contemplated that a large-scale format of the present invention may be provided for recharging batteries such as those used in electric and/or hybrid vehicles. The scope of the invention, therefore, should be defined by the claims as set forth below rather than by the examples expressly illustrated, described or suggested.

What is claimed is:

1. A system for providing energy to an electronic device having a rechargeable power source, the system comprising a metal-air battery comprising one or more zinc-air cells within a housing comprising at least one opening therein for permitting the influx of air from the surrounding ambient into the interior of the battery for exposure to the one or more cells, the battery further comprising a cover that may be entirely or partially moved relative to the air hole for selectively controlling the exposure of the opening to the ambient when it is desired to generate energy for discharge to the rechargeable electronic device.

2. The system of claim 1 further comprising a connector for permitting electrical connection between the system and the electronic device.

3. The system of claim 1 further comprising a carriage for supporting the battery in a manner where the battery may be easily removed and/or repositioned.

4. The system of claim 3 further comprising a connector for permitting electrical connection between the system and the electronic device.

5. A system for providing energy to an electronic device, the system comprising a metal-air battery comprising one or more metal-air cells within a housing with a first surface having at least one air hole therein for permitting the influx of air from the surrounding ambient into the interior of the battery for exposure to the one or more cells, the system further comprising a carriage for supporting the battery in a manner where the battery may be easily removed and/or repositioned.
